(19) United States
(12) Patent Application Publication
(10) Pub. No.: US 2013/0242083 A1
(43) Pub. Date: Sep. 19, 2013

(54) RETRO-REFLECTIVE IMAGING

(71) Applicants: Timothy A. Potts, Westport, CT (US); Arkadiusz Obuchowski, New Hyde Park, NY (US); Siva Sai Rajesh Ogirala, West Haven, CT (US)

(72) Inventors: Timothy A. Potts, Westport, CT (US); Arkadiusz Obuchowski, New Hyde Park, NY (US); Siva Sai Rajesh Ogirala, West Haven, CT (US)

(21) Appl. No.: 13/878,011

(22) PCT Filed: Oct. 7, 2011
(86) PCT No.: PCT/US11/55206

§ 371 Date: Apr. 5, 2013

Related U.S. Application Data
(60) Provisional application No. 61/391,301, filed on Oct. 8, 2010.

(51) Int. Cl. H04N 7/18

(52) U.S. Cl. CPC H04N 7/18
USPC 348/125

(57) ABSTRACT

Methods, systems, and apparatus for imaging a substrate through the use of retro-reflective optics and detecting any defects and patterns therein. Through the use of optical imaging, optical focusing is adjusted to capture optical effects of interest in the substrate with enhanced size, precision, clarity and image quality. Imaging data obtained from these images may then be analyzed. Both bright field image data and dark field image data are captured and analyzed to provide accurate and reliable imaging results. The invention is suitable for use in on-line, real-time detection of visual defects and pattern recognition or off-line for non-production use.

### PRIORITY

This application claims priority to PCT Application No. PCT/US2011/055206 filed Oct. 7, 2011, which claims priority to Provisional Application No. 61/391,301 filed Oct. 8, 2010.

### BACKGROUND OF THE INVENTION

1. Field of the Invention

The invention relates, in general, to the field of imaging, and in particular, to methods, systems, and apparatus for detecting defects and patterns in substrates.

2. Description of Related Art

Electro-optical imaging is often used to detect and identify defects and/or patterns within or on substrates. These substrates include manufactured materials, such as, metal sheets, plastic or non-metallic panels or webs, and glass. The examined materials may be transparent, semi-transparent, opaque or even reflective.

Automatic inspection systems are commonly used in electro-optical imaging operations to quickly detect defects and patterns in or on a substrate. Through the use of automatic inspection systems, stationary or moving sheets are examined for defects and patterns with greater resolution than can be realized by human inspection. Conventional automatic inspection systems include flying spot laser systems, substrate focused camera systems and off-substrate focused camera systems. All of these systems have limited resolution of the image being scanned and obtained.

Referring to flying spot laser systems, these systems have a laser that scans across the surface of a substrate, and optics focus on the substrate itself for detecting any defects. While this approach is widely used in the glass industry, it is costly, complex and provides images with limited resolution.

Currently available camera imaging systems implement a light source for generating light energy that is focused on the substrate, and either reflects off the substrate or is transmitted through the substrate. Camera optics of these known imaging systems are focused on the substrate itself and capture the image only at the substrate for the inspection thereof and detection of any defects on or within the substrate. In other optics a camera may be focused on an illuminated target whereby effects of an obstruction in front of the target distorts the image captured at the target. This area where the effects of the obstruction is shown in the image of the target is often blurry and distorted, and not a true image of the obstruction itself. Rather, it is merely an image of the distortion of the obstruction residing in front of the target. During imaging of such a target, if a distorted or blurry area of features of the target is observed, then all that is known is that an object is obstructing the view between the camera and the target. Detailed information about the obstructing object itself is not obtained since, again, it is only the blocking effects of the object that are observed, not observations of the object itself.

While known camera imaging systems offer lower costs, simplicity and higher resolution alternatives compared to flying spot laser systems, these conventional camera imaging systems still suffer from difficulties associated with alignment, maintenance, energy usage, resultant image deficiencies and ability to measure and classify defects accurately.

### SUMMARY OF THE INVENTION

According to one embodiment of the present invention, the invention is directed a method of imaging a substrate that includes providing an imaging device having focusing optics and a sensor, and generating light energy that travels along a first optical path toward a substrate. Imaging data is retrieved from the substrate by the light energy contacting the substrate. This light energy containing the imaging data continues to travel and diverge along the first optical path toward a reflective device. The light energy containing the imaging data reflects off the reflective device to return the light energy containing the imaging data within a second optical path. This second optical path travels along the first optical path and towards the imaging device. Focusing optics focus on an imaging plane residing at a location in space within the second optical path, and an image is captured at the location in space of the light energy containing the imaging data within the second optical path. Imaging data is then evaluated to define optical effects of interest of the substrate having both bright field data and dark field data.

In other embodiments, the invention is directed to a system for imaging a substrate that includes an imaging device having focusing optics and a sensor, a reflective component, a light energy with imaging data from a substrate traveling alone a first optical path toward the reflective device, and a second optical path traveling toward the imaging device and having the returned light energy containing the imaging data. The system also includes an imaging plane residing at a location in space within the second optical path, along with a central processing unit (CPU), computer readable memory, computer readable storage media and sets of program instructions. The first program instructions capture an image at the location in space of the light energy containing the imaging data within the second optical path, while the second program instructions evaluate the imaging data from the captured image to define optical effects of interest of the substrate having both bright field data and dark field data. These first and second program instructions are all stored on the computer readable storage media for execution by the CPU via the computer readable memory.

The above and other objects, which will be apparent to those skilled in the art, are achieved in the present invention which is directed to

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates a perspective view of an imaging assembly suitable for use in various embodiments of the invention showing light transmission through a transparent substrate.

FIGS. 2A and 2B illustrate a top plan view and a side view, respectively, of the imaging assembly of FIG. 1 having light transmitted from a light source through the transparent substrate.

FIGS. 3A and 3B respectively illustrate a top plan view and a cross sectional side view along line A′-A of light energy from FIGS. 2A and 2B reflected off a retro-reflector and transmitted back through the transparent substrate.

FIGS. 4A and 4B illustrate an alternate beam splitter imaging assembly suitable for use in the invention respectively showing the top plan view and cross sectional side view along line A′-A of light energy reflected off a retro-reflector.

FIG. 5 illustrates an imaging assembly suitable for use in various embodiments of the invention showing light transmission reflected off a substrate surface.

FIGS. 6A and 6B illustrate a top plan view and a side view, respectively, of the imaging assembly of FIG. 5 having light transmitted from a light source and being reflected off the substrate surface.

FIGS. 7A and 7B illustrate a top plan view and a cross sectional side view along line N-A, respectively, of light energy from FIGS. 6A and 6B being reflected off a retro-reflector and then reflected off the substrate surface.

FIG. 8A illustrates a top plan view of an imaging assembly of the invention showing light being transmitted either through or being reflected off a substrate and contacting a retro-reflector.

FIGS. 8B and 8C respectively illustrate a top plan view and a cross-sectional side view of light energy from FIG. 8A being reflected off the retro-reflector and either transmitting through the substrate or reflected off the substrate, with the optical imaging regions of interest being located a distance away from both the substrate and the retro-reflector.

FIG. 9A depicts a defect in a transparent glass substrate optically imaged at location 9 of FIGS. 8B-C.

FIG. 9B depicts the same defect as in FIG. 9A optically imaged at location 10A.

FIG. 9C depicts the same defect as in FIGS. 9A and 9B optically imaged at location 10B.

FIG. 10A depicts a defect on a surface of a reflective substrate optically imaged at location 9 of FIGS. 8B-C.

FIG. 10B depicts the same defect as in FIG. 10A optically imaged at location 10B.

FIGS. 11A-11C depict various defects observed in a plastic film optically imaged at location 9 of FIGS. 8B-C.

FIGS. 12A-12C depict the same corresponding defects observed in FIGS. 11A-11C optically imaged at location 10B of FIGS. 8B-C in accordance with the invention.

### DESCRIPTION OF THE PREFERRED EMBODIMENT(S)

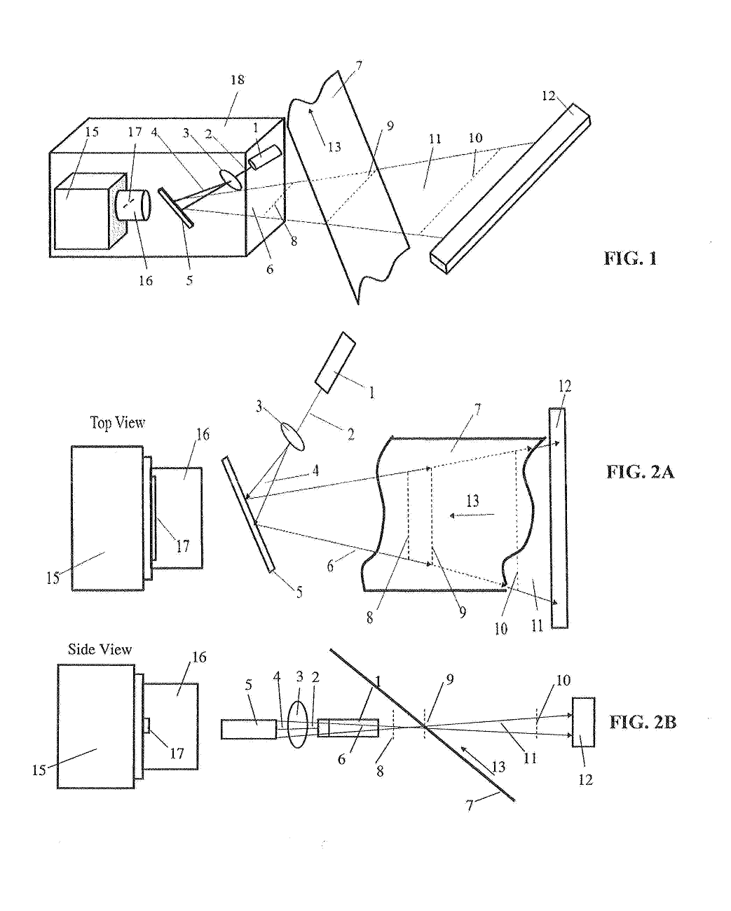

In describing the preferred embodiment of the present invention, reference will be made herein to FIGS. 1-12A of the drawings in which like numerals refer to like features of the invention.

In describing the embodiment of the present invention, reference will be made herein to FIGS. 1-12C of the drawings in which like numerals refer to like features of the invention.

The various embodiments of the invention are directed to methods, apparatus and solid-state systems using retro-reflective optics that enhance imaging and detection of defects and patterns on webs and sheets. The invention is suitable for use in automatic inspection operations involving on-line, real-time detection of visual defects and pattern recognition using a self-aligning optical imaging module as well as off-line use (i.e., not on the production line).

In accordance with the various embodiments of the invention, by focusing the optics to a location of interest, at a specific time in the optical imaging processing, an enhanced image of optical effects of interest that occlude light energy is obtained in the energy reflected off the retro-reflective component. It should be appreciated and understood that the image may capture one or more magnified optical effects of interest including, but not limited to, defects and/or patterns having enlarged dimensions, increased clarity, higher resolution, additional optical fields and combinations thereof.

The detected optical effects of interest may reside within the substrate, on a surface of the substrate, or even reside both within and on a surface of the substrate. The invention electro-optically senses, detects and identifies a variety of optical effects of interest. These optical effects of interest may be defects that optically occlude the light energy including, but not limited to, gaseous bubbles, streaks, tears, craters, indents, outdents, creases, coating defects, buckles, spring back, high spots, low spots, dish shapes, other geometric distortions from irregularities in the dies or molds used to manufacture the part or from handling damage, and even defects due to contaminants. Again, it should be appreciated and understood that one or more optical effects of interest may reside within or on a single substrate and may be detected simultaneously.

Webs and sheets suitable for use in the invention may be planar substrates (i.e., those having flat surfaces), or they may be non-planar substrates (i.e., those having uneven surfaces). Substrates may even have both planar and non-planar surfaces. These substrates may be composed of a transparent material, semi-transparent material, opaque material, reflective material, materials having a reflective coating on a surface thereof, or even combinations of any of the foregoing composites. In one or more embodiments, the substrates may include, but are not limited to, sheet metal, glass, plastic sheets or webs (e.g., plastic panels, plastic film, etc.), paper sheets or webs, or any other type of substrate that is either transparent, reflective, or has a reflective layer on a surface thereof.

The numerous substrates suitable for use in the invention may be for a variety of industries that rely on operations involving on-line, real-time feedback of defect detection data for process and quality control. These industries include, for example, solar photovoltaic, glass display, flexible electronics, films, metals, paper, auto body parts (e.g. plastic panels for hoods, fenders, doors, etc.), aircraft panels, appliance/furniture surfaces and panels, pharmaceuticals (e.g., films and/or papers for use in pharmaceuticals), and the like.

Referring now to the drawings, FIG. 1 depicts an imaging assembly suitable for use in various embodiments of the invention. The imaging assembly includes a scanner 18 at least having a radiation source 1, optics 3, a first reflection device 5 (e.g., a mirror or a beam splitter), and an imaging device 15 having focusing optics 16 and a sensor 17. The radiation source may include, but is not limited to, a laser, light emitting diode, another source of visible or invisible radiation, a ring of light axially coincident with the imaging device and sitting outside of the field of view of the focusing optics, and the like. For ease of understanding the invention, the radiation source is shown as a laser 1.

The laser 1 initiates a first optical path by generating a beam of light energy 2 that is transmitted through a beam shaping optical component 3. The laser 1 may be a gas or solid-state laser, a light emitting diode (LED), or other radiation source. The beam shaping optical component 3 expands the light energy beam 2 to increase the angles of the beam in both the azimuth and elevation planes. The shaping optics 3 may be integrated with the laser 1 or it may be a component separate and distinct from the laser. The resultant, expanded beam 4 is focused onto and reflected off the first reflection device 5 to provide a beam 6 that is expanded even further as it approaches the substrate 7 it is to be transmitted through or reflected off

The first reflection device 5 may be a mirror (see, FIGS. 1-3B and 5-7B) or a beam splitter (see, 4A-B). While not departing from the novel concepts of the invention, it should be appreciated that other reflection devices may be suitable for use in the invention. In one or more embodiments, the reflection device 5 may be positioned in front of one or more imaging devices to direct the first optical path away from such components and toward the substrate that is to be analyzed for optical effects of interest (e.g., defects, patterns, haze, etc.)

In embodiments where the first reflection device 5 is a mirror, the mirror may be a thin opaque reflective device. For instance, the mirror may include a front or back mirror surface (e.g., glass or plastic), polished metal or metallized medium. In those embodiments where the mirror is glass or plastic, the mirror may allow light energy to be transmitted. The mirror may cover a small area of the focusing optics 16, a large section of the focusing optics 16, or it may even cover all of the focusing optics 16. Also, the mirror may be adjusted relative to the imaging device 15 so that a variety of images may be captured at different angles, depths, sizes, and the like.

In other embodiments, the first reflection device 5 may be a beam splitter that provides multiple views and images of the same defect. The use of a beam splitter, in combination with multiple imaging devices 15, 19, etc., also allows the focusing optics of each imaging device to be focused on different planes in space to capture images of the same optical effect of interest (e.g., defect or pattern) at different distances away from the second reflective device 12. This allows components of the invention (e.g., electronics and software) to utilize the different photographical views of the same optical effect of interest for analysis and comparison to one another to extrapolate imaging data and information about the optical effect of interest that otherwise would not be available by imaging such optical effect of interest only at the substrate itself

In those embodiments where the first reflection device 5 is a beam splitter, a portion of the beam splitter directs the first optical path toward the substrate 7. Another portion of the beam splitter may split the reflected second optical path toward one or more imaging devices. That is, the use of a beam splitter allows unimpeded collection of the return energy in the second optical path to enter the one or more imaging devices.

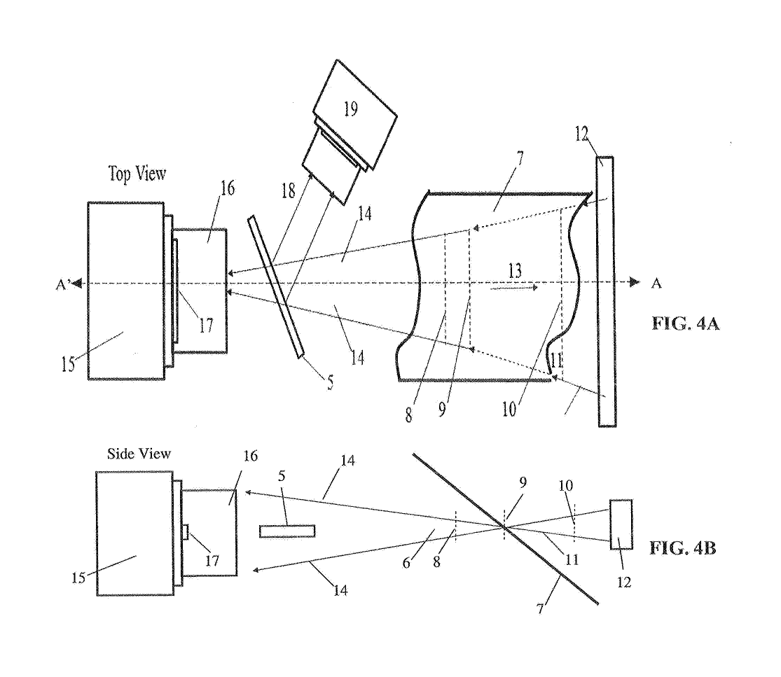

For instance, referring to FIGS. 4A-B, the beam splitter may reflect the returned light energy in the second optical path along a first return energy path toward a first imaging device 15 and along a second return energy path toward a second imaging device 19. As such, the light energy of the second optical path may be imaged by one or more separate imaging devices (e.g., imaging devices 15 and 19). This approach allows multiple image views of one or more regions of interest to be captured for extracting and collecting additional optical data relating to any defects, patterns, etc. at such locations.

Referring again to FIGS. 1-3B, in one or more embodiments the substrate 7 may be a transparent substrate. For instance, the substrate may be a clear web or sheet of material including, but not limited to, a plastic film or glass. In those embodiments wherein the substrate 7 is transparent, the light energy beam 6 contacts the transparent substrate 7 at a front surface thereof, is transmitted entirely through the substrate 7, and is transmitted out at the back surface of the substrate. The location where the light energy beam 6 contacts the transparent substrate 7 corresponds to a scan line 9 that resides at the substrate 7. The light energy beam 11 emerging from the substrate along the first optical path is further expanded. Together, light energy beams 2, 4, 6 and 11 comprise the first optical path.

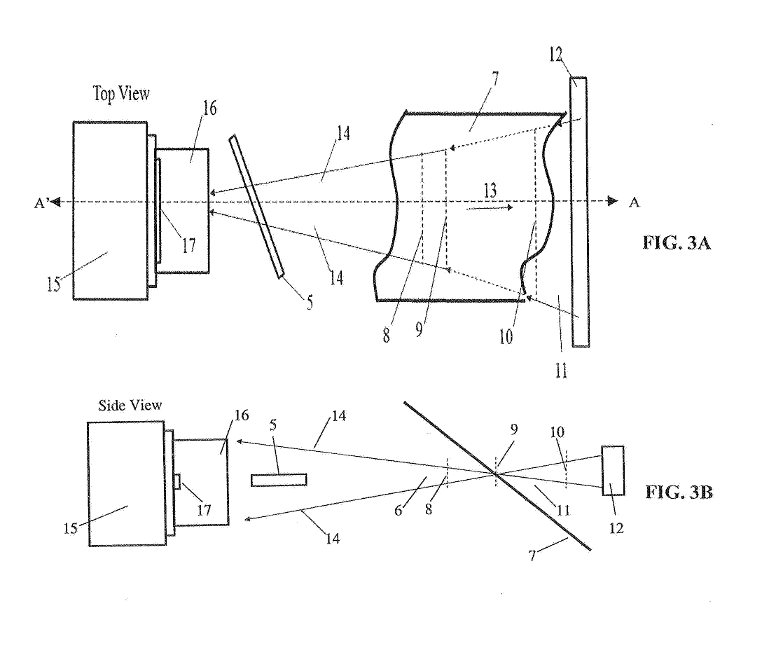

FIG. 2A shows the first optical path traversing through a transparent substrate while the corresponding cross sectional view, along line A′-A, is shown in FIG. 2B. The first optical path contacts a second reflective device 12 at a back side of the substrate that reflects light energy of the first optical path off its reflective surface and projects it as returned energy along a second optical path 14, FIG. 3A. The second reflective device 12 may be any type of reflective or diffusing medium that reflects light energy off its surface in a desired direction. While not meant to limit the invention, in one or more embodiments, the second reflective device may include, but is not limited to, a retro-reflective medium, a radiation scattering screen, and the like. In those embodiments that implement a retro-reflector, the retro-reflector may be an elongated component that has numerous glass spheres, cubes, prisms or other devices on its surface for reflecting light from the first optical path in various directions. This retro-reflector device is preferably in alignment with the laser beam

Referring to top and cross-sectional views of FIGS. 3A and 3B, respectively, the returned energy of the second optical path 14 is shown as being directed back through the transparent substrate 7, and toward both the first reflection device 5 and the imaging device 15 having the focusing optics 16 and sensor 17. As the first optical path light energy approaches the second reflective device 12 the light energy diverges, such that, the first optical path has its largest dimensions at the location at which the first optical path contacts the second reflective device (see, FIG. 2A). The second reflective device 12 receives and reflects this light energy. The light energy is returned along the path of incidence of the first optical path, at least along light energy beams 6 and 11. That is, the returned energy from the second reflective device 12 travels along essentially the same plane as the projected energy of the first optical path. This returned energy may have a slight amount of divergence from the first optical path. For instance, the second optical path 14 may diverge from the first optical path to a degree of less than or equal to about 2°. This divergence of the second optical path 14 may be increased in one or two planes including, for instance, being increased in both altitude (i.e., pitch) and azimuth (i.e., yaw).

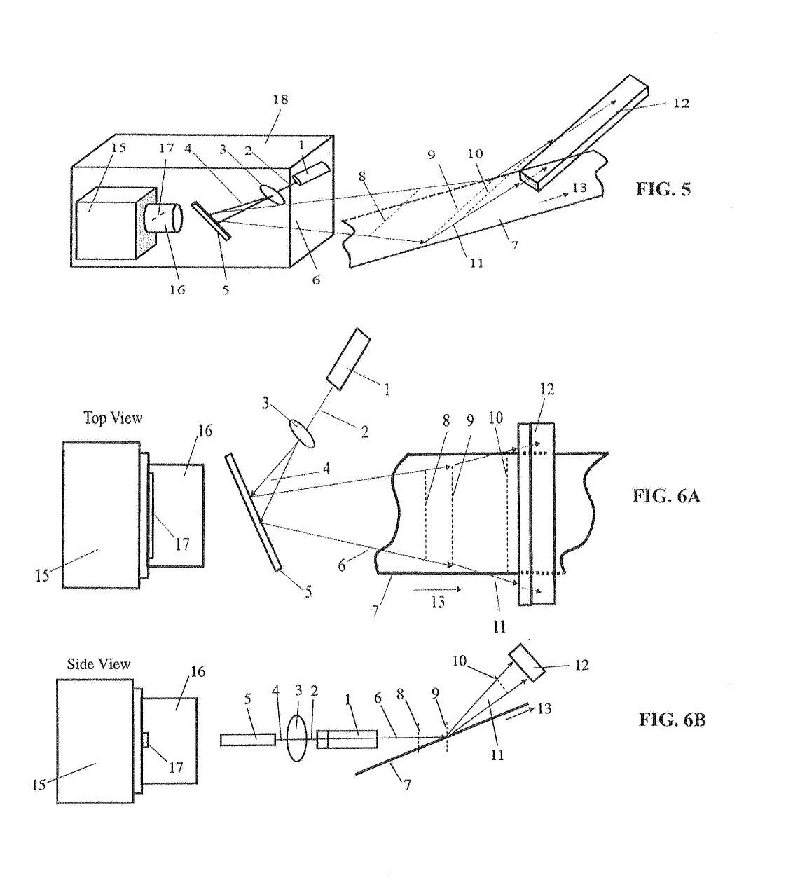

Referring now to FIGS. 5-7B, rather than the substrate being a transparent substrate, the substrate may be reflective, or have a reflective surface, that needs to be analyzed for optical effects of interest. For instance, the substrate may be a sheet of foil, or it may be a sheet or web of paper or inorganic material that has a reflective layer on a surface thereof, like coated glass.

As shown in FIG. 5, the system still includes radiation source 1, optics 3, first reflection device 5, imaging device 15 having focusing optics 16 and a sensor 17 (or it may have two ore more imaging devices 15, 19 as described above), and the second reflective device 12. However, in embodiments where the substrate being analyzed is reflective, all components used for such analysis reside, or are located, in front of the substrate surface that is being scanned, imaged and analyzed.

In particular, in those embodiments that include analyzing a transparent substrate the radiation source 1, optics 3, first reflection device 5, and imaging device 15 all reside on a first surface (or front side) of the substrate while the second reflective device 12 resides on a second, different surface (or back side) of the substrate. However, when the substrate 7 is reflective the second reflective device 12 resides on the same side of the substrate as that of the radiation source, optics, first reflection device and imaging device(s) as shown in FIGS. 5-7B.

In those embodiments where the substrate 7 being analyzed is reflective, the light energy beam 6 contacts the reflective substrate 7 at a first surface thereof and is reflected off this first surface toward the second reflective device 12. It should be appreciated that this first surface of the reflective substrate may be a back side or a front side of the reflective substrate. Again, together the light energy beams 2, 4, 6 and 11 comprise the first optical path which diverges as the first optical path approaches the second reflective device 12 (see, FIGS. 6A-6B). The point at which the first optical path contacts the reflective substrate 7 corresponds to a scan line 9 that resides at the substrate 7.

Once the first optical path contacts the second reflective device 12, light energy of the first optical path is reflected off the second reflective device 12, and is returned along the path of incidence of the first optical path. This returned light energy is the second optical path 14 that also diverges and expands (e.g., in the altitude (pitch) and azimuth (yaw) directions) beyond the path of incidence of the first optical path (see, e.g., FIG. 2A). The returned light energy of this second optical path 14 contacts and reflects off the first surface of the substrate, and is then directed toward both the first reflection device 5 and the one or more imaging devices (e.g., imaging devices 15 and 19).

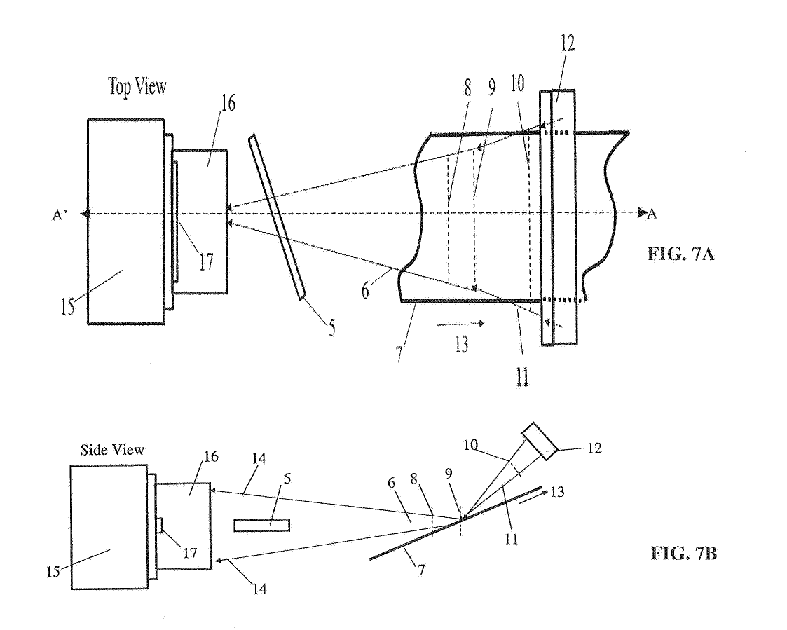

Referring to FIGS. 3A and 7A, regardless of whether the returned energy 14 of the second reflective device 12 is from a transparent substrate or a reflective substrate, this returned light energy 14 converges as it approaches the substrate 7 and is either transmitted through or reflected off the surface thereof. This light energy then continues to converge as it extends toward the first reflection device 5 and the imaging device 15. While a portion of the returned light energy travels along the path of incidence of the first optical path, this energy converges on and is blocked by the first reflection device 5. For instance, in embodiments where the first reflection device 5 is a mirror, the mirror and sensor 17 may be adjusted relative to each other so that the mirror entirely blocks the sensor 17, partially blocks the sensor 17 or does not block the sensor 17 at all.

The remainder of the energy in the second optical path 14 diverges from the path of incidence of the first optical path. The divergent energy of the second optical path does not return to the first reflection device 5 (e.g., mirror), and as such, is not blocked. This divergent energy of the second optical path is the energy of interest in accordance with the various embodiments of the invention.

The energy of interest from the second optical path 14 contacts and is received at the one or more imaging devices (e.g., imaging device 15 when a mirror is used, or even imaging devices 15 and 19 when a beam splitter is used). Again, each imaging device 15, 19 includes focusing optics 16 and a sensor 17. The imaging device may be a line scan camera. The sensor 17 may be a linear array of pixels as used in a line scan camera, a matrix array, CMOS array or other device that converts light energy into gray scale and/or color pixels or images.

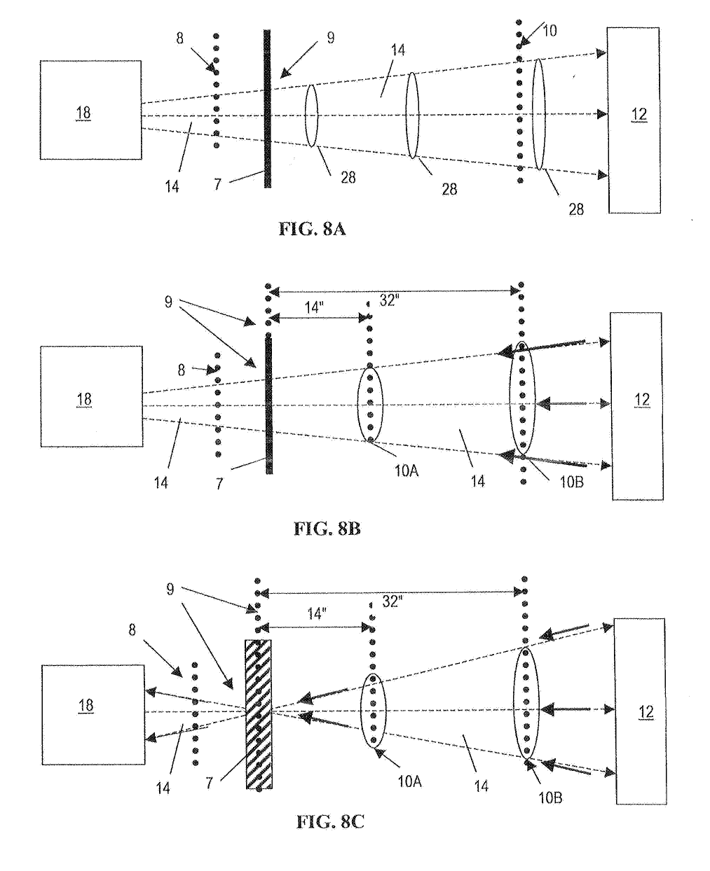

The imaging device 15, 19 receives the energy of interest from the second optical path 14, which includes data relating to any optical effects of interest that may reside within or on the substrate. The imaging device converts this received energy of interest into an electronic image or signal via the focusing optics 16 and sensor 17. Photo-multipliers may also be used to transform the light energy into an electronic signal. In doing so, the focusing optics 16 is focused on one or more different imaging planes that the second optical path 14 travels along and through. Referring to FIGS. 8A-8C, these one or more imaging planes within the returned light energy of the second optical path 14 may reside at various location along the second optical path 14.

In one or more embodiments, the imaging plane may be at a first imaging plane 8 residing at a spatial point or location within space between the imaging device 15, 19 and the substrate 7. In other embodiments, the imaging plane may be at a second imaging plane 10 residing at a spatial point or location within space between the substrate 7 and the second reflective device 12. Focusing optics may also be directed at a third imaging plane 9 that corresponds to the location where the light energy contacts the substrate, whereby other embodiments include obtaining images at any combination of these imaging planes 8, 9, 10.

For instance, one or more focusing optics 16 (of one or more imaging devices 15, 19, etc.) may focus on a combination of these imaging planes 8, 9, 10 for simultaneously obtaining a combination of images at the respective imaging planes to provide additional data pertaining to the optical effects of interest in or on the substrate. By focusing the focusing optics 16 on the different imaging planes 8, 9, 10 the sensor 17 may detect defects and/or patterns within the processed substrate 7. Depending upon at which imaging plane(s) 8, 9, 10 an image is captured, the defects and/or patterns will appear differently. The appearance of any defects or patterns that may be captured at any of these planes may also be changed by altering the mirror size, by changing the position of the mirror relative to the sensor, or even by replacing the mirror with an alternate optical device or devices (e.g., beam splitters, polarizing filters, and the like). In still other embodiments, an additional optical element may be positioned between the imaging device 15 and first reflection device 5 to modify the returned energy in the second optical path 14 prior to it entering the imaging device 15.

In various embodiments of the invention, the image or series of images of the substrate are preferably captured in the returned energy of the second optical path 14 at an imaging plane just off of the second reflective device 12. By photographically capturing the image of any defect(s) and/or patterns within space just off the second reflective device 12, such images will be easier to capture, and be larger in size with good depiction quality and clarity, as compared to images captured directly at the substrate itself. The image(s) captured in the returned energy, prior to such energy contacting the substrate, may have defects or patterns captured in such images that may be anywhere from about 2 to about 22 times larger than the same defects or patterns captured in images taken at the substrate itself. The closer the image is taken to the second reflective device 12, the larger its image size and the better the quality of any optical effects of interest captured in such image.

The imaging device(s) may obtain a series of images at any one of the imaging planes 8, 9, 10, or combinations thereof. For instance, the imaging device may be a line scan camera that captures a series image frames. Each of these images within the series represents an image slice of the subject 7 at the specific imaging plane that the focusing optics 16 is focused on. It should be appreciated and understood that the rate at which the imaging device captures the series of image frames may be related to shutter speed of the imaging device, as well as related to the speed at which the substrate 7 moves in direction 13 along a conveyer belt, on a track or on rollers. The substrate moves in direction 13 relative to scanner 18. In one or more embodiments, the laser 1, optics 3, mirror 5, imaging device 15, focusing optics 16 and sensor 17 may be mechanically linked together and do not move relative to each other and to the substrate 7 during operation.

The systems of the invention may also include electronic components and one or more sets of instructions (e.g., software) for analyzing the series of obtained images to detect optical effects of interest within the substrate. Again, these optical effects of interest may include, but are not limited to, defects, imaging patterns, and/or measure the amount of haze in the processed substrate 7. All of these optical effects of interest may enhance, reduce, distort and/or scatter light energy (i.e., occlude the light energy) in a detectable and measurable manner. In doing so, a plurality of the captured image frames or series of images may be used to generate a substantially three dimensional graphical representation of the substrate, including any defects, patterns and/or haze within the substrate or on a surface thereof. Topographical data of the substrate may also be generated using this data.

FIG. 8A is a representation of the projected energy of the first optical path either being transmitted through the substrate or being reflected off the substrate. As this projected light energy approaches the second reflective device 12, imaging data 28 of the imaged substrate 7 enlarges as it travels along the diverging (i.e., expanding) first optical path. As is shown, the closer to the second reflective device 12, the larger the imaging data 28.

Referring to FIG. 8B, upon contact of the first optical path to the second reflective device 12, the light energy is reflected off the reflective surface and is expanded even further in the returned second optical path 14. Now the light energy converges in a direction from the second reflective device 12 toward the imaging device of scanner 18, as is shown in FIG. 8C. The imaging data of the substrate is now expanded even further in this second optical path 14, whereby the largest region of imaging data 10B resides closest to the second reflective device 12 and is reduced in size as it approaches the substrate 7. For instance, the region of imaging data 10A is smaller in comparison to the region of imaging data region 10B within the second optical path 14.

In accordance with the various embodiments of the invention, by focusing the optics 16 at an image plane in space within the second optical path 14, and preferably at an image plane close to the second reflective device 12, images of defects, patterns and/or haze are dramatically increased and/or enhanced in size, clarity, quality and detectability. It should be appreciated and understood that the distance an image may be taken in space depends upon the physical and/or chemical characteristics of the substrate being analyzed. It should also be appreciated that the distance between the substrate and the second reflective device 12 will vary that depending upon the substrate material itself. This distance is chosen so that the second reflective device 12 resides a suitable distance away from the substrate whereby it is able to adequately capture and return the light energy of the first optical path.

FIGS. 8B and 8C show multiple imaging plane regions of interest having imaging data (e.g., imaging plane 10 having regions 10A and/or 10B) that may be captured by one or more imaging devices to obtain enhanced imaging results in accordance with the invention. In the invention, imaging plane regions of interest within the returned energy may also reside within space at locations between the substrate and the imaging device. For instance, the focusing optics 16 may be focused on imaging plane 8 to obtain a different view of optical images that provides additional imaging data.

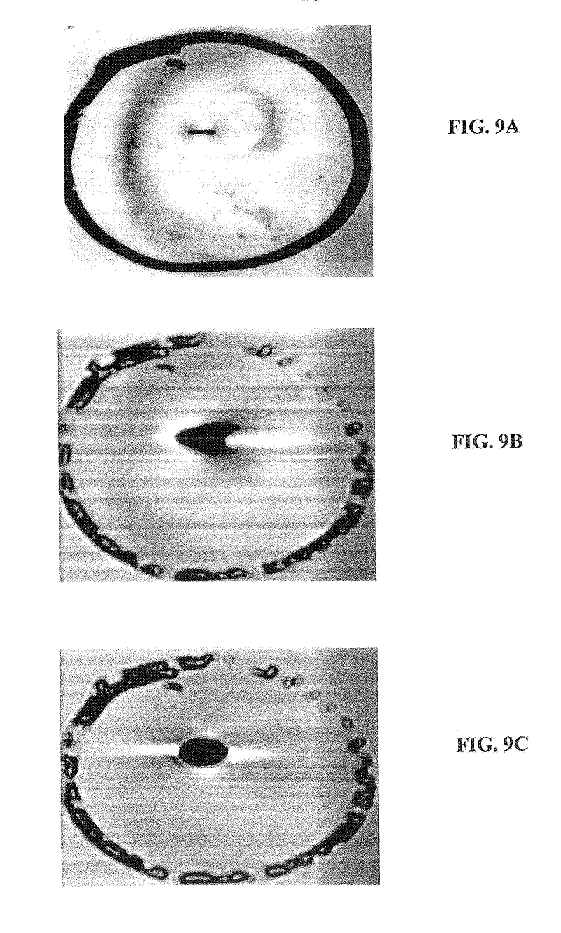

The additional imaging data includes the capture of both bright field data and dark field data. In the captured image data and results of the invention both dark spots and lights spots are captured (see, e.g., FIGS. 9A-9C, which are discussed in detail below). The dark spots in FIGS. 9A-C are where light is being absorbed by the optical effect of interest (e.g., by a gas bubble) while the light spots in images FIGS. 9B-9C (which were taken between the substrate and retro-reflector) are of the light energy being bent. This bent light (i.e., the light spots) represents additional optical effects of interest (e.g., additional defects, patterns, etc.) that reside within the substrate in addition to the optical effects of interest (e.g., defects, patterns, etc.) detected and shown as the dark spots. These additional defects may be a part of, or caused by, the optical effects of interest represented by the dark spots in the images. The collected data from the dark spots is referred to as bright field data, while the collected data from the light spots is referred to as dark field data. As such, with the optical imaging of the invention that captures images of defects in space, additional imaging data from two optical data fields is obtained. In particular, both bright field data and dark field data are obtained simultaneously. In comparison, by capturing images of defects at the substrate itself (see, e.g., FIG. 9A), only bright field data (i.e., the dark spots) is obtained.

While reference is made herein to the imaging devices being on the first side of the substrate being analyzed, it should be appreciated and understood that optical imaging devices (e.g., cameras) may alternatively be positioned in a close proximity to the returned light energy path of interest in the second optical path 14. For instance, for transparent substrates the optical imaging device may positioned at the back side of the substrate so that it resides between the substrate and second reflective device 12 for capturing images within image plane regions 10A and/or 10B. These images may be captured as side view images of these regions 10A and/or 10B. In addition thereto, an optical imaging device may also reside within the direct path of the second optical path 14 as shown in FIGS. 3A-B so that frontal images as well as side view images of optical effects of interest at regions 10A and/or 10B may be obtained simultaneously. It should also be appreciated that when the substrate is transparent, one or more optical imaging devices may be positioned over the location between the substrate and second reflective device 12 to obtain side view images. Still further, imaging devices may be provided either over or under such regions of interest to capture top views or bottom views, respectively, of these image plane regions.

### EXAMPLES

While not meant to be limiting, the following examples refer to imaging results in accordance with the invention, as shown in FIGS. 9A-12C.

FIGS. 9A-9C show the results of a glass substrate analyzed for defects. The scanner 18 with imaging device 15 resides on a first side of the glass substrate while the second reflective device 12 resides on the second side thereof. Light energy was transmitted through the glass substrate and reflected off the second reflective device to generate the second optical path 14 of interest. The focusing optics 16 were focused on various imaging planes 9, 10A and 10B (i.e., regions of interest) along and within the second optical path 14. A gaseous bubble was detected within the glass substrate and is shown as the dark spot residing in the center of the highlighted circle (i.e., highlighted and imaged with a marked black ink ring).

FIG. 9A shows the gaseous bubble imaged at image plane 9 which resides at the substrate. Bubbles are gaseous inclusions in the glass and typically cause light to be both absorbed (in the center of the bubble) and distorted (at the ends and sides of the bubble). As is shown, the imaged glass bubble is depicted as being barely detectable with limited clarity and quality and being of a diminished image size. By capturing the image of the defect at the substrate bright field data only is obtained. This limits the data that can be extrapolated and analyzed for interpretation and identification of the defect.

FIG. 9B shows the gaseous bubble imaged at image plane 10A which resides about 14″ away from the substrate 7. Again, this imaged region of interest resides within the returned energy of the second optical path 14. As is shown, the gaseous bubble defect is more detectable, has increased clarity and quality, and is larger in size than the image of the bubble taken at the substrate in FIG. 9A. The image of FIG. 9B shows both bright field data and dark field data.

Results of the gaseous bubble of FIGS. 9A and 9B imaged at image plane 10B are shown in FIG. 9C. This image plane 10B is closer to the second reflective device 12 than that of 10A, and resides about 32″ away from the substrate 7 and about 1-2″ off the second reflective device 12 (e.g., off the retro-reflector). Again, it should be appreciated that the distance an image is taken is space will depend upon the physical and/or chemical characteristics of the substrate being analyzed. Since this image is taken close to the second reflective device 12 its size is significantly enhanced and enlarged due to it being within the larger section of the converging light energy of the second optical path 14. The gaseous bubble in FIG. 9C has significantly enhanced and increased clarity and quality, as well as being larger in size than the image of the bubble taken at both the substrate in FIG. 9A and at image plane 10A in FIG. 9B. This larger image size of FIG. 9C allows for easy detection of any optical effects of interest in the substrate. It also provides for enhanced detection and capturing of both bright field data and dark field data over that of FIG. 9B.

By intercepting the gaseous bubble just after the light energy interacts with the second reflective device 12, the gaseous bubble and its optical effects (absorption and distortion) are captured much larger, and the resultant bubble image both covers more optical pixels and is sized more accurately. As such, gaseous bubble defect detection, sizing and information leading to classification are enhanced in accordance with the various embodiments of the invention. This leads to utilizing less optical pixels and processing energy, thereby leading to reduced processing costs.

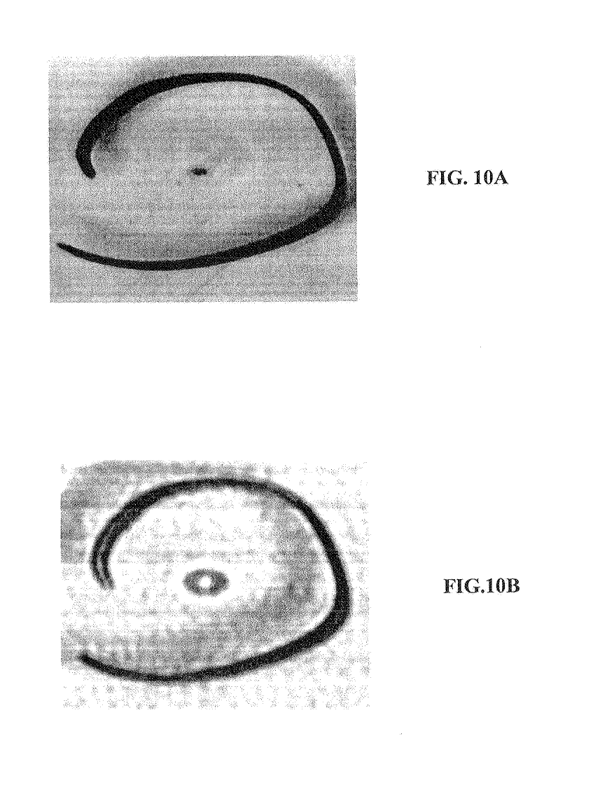

As an alternative to analyzing a transparent substrate in FIGS. 9A-C, a reflective substrate may be analyzed as shown in FIGS. 10A-B. The substrate is a reflective film that has been processed in accordance with the invention, whereby light energy has been reflected off the second reflective device 12 and then off the substrate surface. The defect captured may be, for instance, a missing section, indent, outdent, etc. within the reflective surface that causes light to the distorted and/or scatter in a detectable and measurable manner.

Referring to FIG. 10A, the defect in the reflective substrate is imaged at the image plane 9 corresponding to the location of the substrate itself. As is shown, the imaged defect is depicted as being barely detectable with limited clarity and quality, and being of a diminished image size. However, referring to FIG. 10B of the invention, the imaged defect is imaged at image plane 10B residing about 32″ away from the substrate (i.e., it is closer to the second reflective device 12 as compared to its distance to the substrate). This image in FIG. 10B shows a defect in the reflective layer that is significantly enlarger in size and enhanced in detectable, clarity and quality due to it being within the larger section of the converging light energy of the second optical path 14.

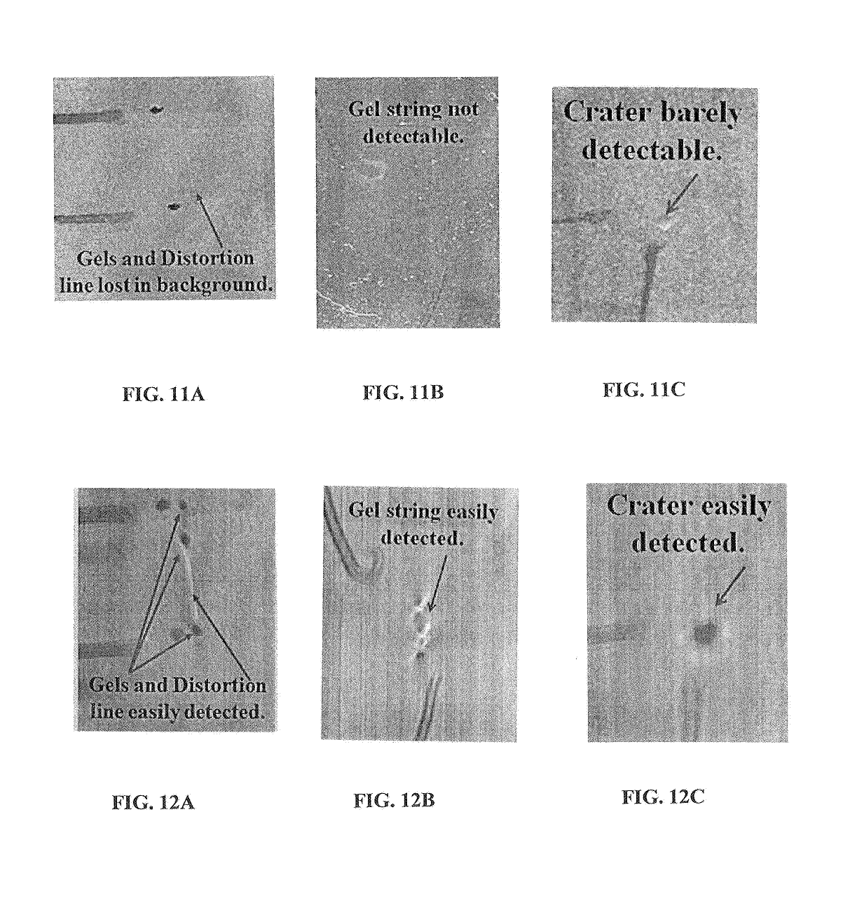

FIGS. 11A-11C show other examples of a plastic film being imaged in accordance with the invention. In these images, gels and a distortion lines (FIG. 11A), a gel string (FIG. 11B) and a film crater (FIG. 11C) are all shown imaged at image plane 9 corresponding to the location of the substrate itself. As can be seen the defects and/or distortions are barely detectable, are unclear, have impaired quality, and are diminished image size. However, referring to FIGS. 12A-12C of the invention, the same imaged defects and/or distortions of FIGS. 11A-11C are imaged at image plane 10B residing about 32″ away from the substrate. All of these images show the defects and/or distortions having significantly increased size for easy detection, as well as having enhanced clarity and quality as compared to the image results of FIGS. 11A-11C.

Thus, the methods, apparatus and systems of the invention provided imaged frames of light energy from within energy returned from the reflective component. These images are captured at a point in space that resides just off the reflective component to provide images having easier detectability of any optical effects of interest therein, increased clarity and quality of such optical effects of interest, as well as larger image sizes thereof.

The optical system of the invention may be in a single module, such as, scanner 18. The laser 1, focusing optics 3, first reflection device 5 and imaging device 15 or 19 having the focusing optics 16 and sensor 17 all preferably reside within the single module of the scanner 18. The second optical path 14 (i.e., the returned energy) is collected by the focusing optics 16, which focuses this energy onto a sensor 17. The sensor is attached to the imaging device 15. The optical imaging device of the invention is self-aligning, and as such, is less affected by ambient light and is not affected by substrate bounce and/or surface roughness (i.e., any departure from surface flatness).

In various embodiments of the invention both bright field data and dark field data are provided at one or more imaging planes in space so that the substrate is analyzed or checked for quality control in an easy and efficient manner. The bright field data and dark field data, as well as the multiple imaging plane data, enables a more detailed and extensive review, analysis and interpretation of optical effects of interest data as compared to those systems that only image and capture optical effects of interest at the substrate itself. As such, the invention rapidly, automatically and objectively evaluates such optical effects of interest (e.g., defects, patterns, haze, etc.), thereby providing improved manufacturing quality and process control.

The present invention is different from those imaging systems that merely obtain the effects of an object's distortion on a target that the object blocks. Again, in such systems an object (e.g., a defect) resides between a camera and a target being imaged, whereby imaged distortion on the target indicates that an object is blocking or in front of such target. It does not provide detailed information about the object itself or a true image of the object since the object is not imaged. Rather it is merely object distortion that is captured to indicate that a blurring and/or distorting object exists. On the contrary, the various embodiments of the invention actually image and capture the optical effects of interest, defect, object, etc. itself. The invention images the optical effects of interest, defects, objects, etc. themselves by imaging in the reflected energy reflection data of the imaging data obtained from the substrate. That is, the reflection of the substrate image is captured so that the reflections of any optical effects of interest residing within or on the substrate are also captured. That is, the optical effects of interest, defects, objects, etc. themselves are imaged or captured. As such, detailed data about the optical effects of interest, defects, objects, etc. is extracted and provided in accordance with the invention.

As will be appreciated by one skilled in the art, aspects of the present invention may be embodied as systems, methods or computer program products. Accordingly, aspects of the present invention may take the form of an entirely hardware embodiment, an entirely software embodiment, or an embodiment combining software and hardware aspects that may all generally be referred to herein as a “system.” Furthermore, aspects of the present invention may take the form of a computer program product embodied in one or more computer readable medium(s) having computer readable program code (i.e., a set of instructions) embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

In the context of this document, a computer readable storage medium may be any tangible medium that can contain, store, communicate, propagate, or transport a program for use by or in connection with an instruction execution system, apparatus, or device. Note that the computer usable or computer readable medium could even be paper or another suitable medium upon which the program is printed, as the program can be electronically captured via, for instance, optical scanning of the paper or other medium, then compiled, interpreted, or otherwise processed in a suitable manner, if necessary, and stored in a computer memory.

A computer readable signal medium may include a propagated data signal with computer readable program code embodied therein. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through an Internet Service Provider).

While the foregoing written description of the invention enables one of ordinary skill to make and use what is considered presently to be the best mode thereof those of ordinary skill will understand and appreciate the existence of variations, combinations, and equivalents of the specific embodiment, method, and examples herein. The invention should therefore not be limited by the above-described embodiment. method, and examples, but by all embodiments and methods within the scope and spirit of the invention.

Thus, having described the invention, what is claimed is:

1. A method of imaging a substrate comprising:
providing an imaging device having focusing optics and a sensor;
generating light energy that travels along a first optical path toward a substrate;
retrieving imaging data from the substrate by the light energy contacting the substrate, the light energy containing the imaging data continuing to travel and diverge along the first optical path toward a reflective device;
reflecting the light energy containing the imaging data off the reflective device to return the light energy containing the imaging data within a second optical path, the second optical path traveling along the first optical path and toward the imaging device;
focusing the focusing optics on an imaging plane residing at a location in space within the second optical path;
capturing an image at the location in space of the light energy containing the imaging data within the second optical path; and
extrapolating the imaging data from the captured image to provide optical effects of interest of the substrate having both bright field data and dark field data.

2. The method of claim 1 wherein more than one imaging devices are provided for capturing multiple views of the optical effects of interest of the substrate.

3. The method of claim 1 wherein the light energy is emitting from a radiation source.

4. The method of claim 1 wherein the substrate is a transparent substrate, the light energy within both the first optical path and the second optical path being transmitted through the transparent substrate.

5. The method of claim 1 wherein the substrate is a reflective substrate, the light energy within both the first optical path and the second optical path being reflected off a surface of the reflective substrate.

6. The method of claim 1 further including a reflective component for directing the first optical path toward the substrate.

7. The method of claim 6 wherein the reflective component is selected from the group consisting of a mirror or a beam splitter.

8. The method of claim 6 wherein the reflective component is positioned in front of the imaging device and directs the light energy within the first optical path away from the imaging device.

9. The method of claim 1 wherein the reflective component is a beam splitter, the beam splitter reflecting the returned light energy containing the imaging data within the second optical path to a plurality of imaging devices for capturing several views of the optical effects of interest from several focusing locations within the second optical path.

10. The method of claim 1 wherein the reflective device is selected from the group consisting of a radiation scattering screen or a retro-reflective medium.

11. The method of claim 1 wherein the imaging plane resides at a spatial point in space residing between the substrate and the reflective device.

12. The method of claim 1 wherein the imaging plane resides at a spatial point in space residing between the imaging device and the substrate.

13. The method of claim 1 further including focusing on a plurality of imaging planes using one or more focusing optics, and simultaneously obtaining images at each of these imaging planes.

14. The method of claim 13 wherein the plurality of imaging planes reside at locations along the second optical path selected from the group consisting of all between the substrate and the reflective device; all between the imaging device and the substrate; a combination of locations between both the substrate and the reflective device, and the imaging device and the substrate; or a combination of locations between both the substrate and the reflective device, and at an image plane residing at the substrate.

15. The method of claim 1 further including positioning an additional optical element between the imaging device and reflection device to modify the return light energy of the second optical path prior to the light energy entering the imaging device.

16. The method of claim 1 wherein the light energy in the second optical path diverges from the first optical path in one or two planes.

17. The method of claim 1 wherein the optical effects of interest comprise defects within the substrate or on a surface of the substrate.

18. The method of claim 1 wherein the optical effects of interest comprise a pattern of an image within the substrate.

19. The method of claim 1 wherein the optical effects of interest comprise haze, and further including measuring the amount of haze within the substrate.

20. A system for imaging a substrate comprising:
an imaging device having focusing optics and a sensor;
a reflective component;
light energy that travels along a first optical path toward a substrate, contacts the substrate and obtains imaging data from the substrate, and then continues to travel along the first optical path toward the reflective device;
a second optical path generated by reflection of the first optical path off the reflective device, the second optical path traveling toward the imaging device and having the returned light energy containing the imaging data;
an imaging plane residing at a location in space within the second optical path;
a central processing unit (CPU), a computer readable memory, and a computer readable storage media;
first program instructions to capture an image at the location in space of the light energy containing the imaging data within the second optical path; and
second program instructions to extrapolate the imaging data from the captured image to provide optical effects of interest of the substrate having both bright field data and dark field data,
wherein the first and second program instructions are all stored on the computer readable storage media for execution by the CPU via the computer readable memory.
